(19) United States
(12) Patent Application Publication
(10) Pub. No.: US 2018/0284817 A1
(43) Pub. Date: Oct. 4, 2018

(54) UNIVERSAL FRAC MANIFOLD POWER AND CONTROL SYSTEM

(71) Applicant: FMC Technologies, Inc., Houston, TX (US)

(72) Inventors: James Cook, Houston, TX (US); Dan R. Fink, Porter, TX (US)

(73) Assignee: FMC Technologies, Inc., Houston, TX (US)

(21) Appl. No.: 15/943,402

(22) Filed: Apr. 2, 2018

Related U.S. Application Data
(60) Provisional application No. 62/480,828, filed on Apr. 3, 2017.

(51) Int. Cl. G05D 7/06; E21B 43/26

(52) U.S. Cl. CPC G05D 7/0664; G05D 7/0676; E21B 43/26

(57) ABSTRACT

A universal power and control unit in a manifold system includes a control subsystem having a primary controller and a power subsystem having a power unit and at least one power connection selected from the group consisting of electrical cables, umbilical cables, pneumatic hoses, pneumatic lines, hydraulic hoses, and hydraulic lines for distributing at least one of electrical, pneumatic, and hydraulic power throughout the manifold system.

### CROSS-REFERENCE TO RELATED APPLICATIONS

This application claims benefit, under 35 U.S.C. § 119, of U.S. Provisional Application Ser. No. 62/480,828 filed on Apr. 3, 2017 and entitled “Universal Frac Manifold Power and Control System.” The disclosure of this U.S. Provisional application is incorporated herein by reference in its entirety.

### BACKGROUND

Wells may be drilled in and through subterranean formations for various reasons including the production of fluids, e.g., liquids, gases, or mixtures thereof, from subterranean reservoirs. In the oil and gas industry, these fluids may include water, hydrocarbon liquids and hydrocarbon gases. To enhance the production of these fluids, it may be advantageous to stimulate the well. One method of well stimulation is hydraulic fracturing, or fracing (fracking), where fractures are produced in one or more subterranean zones of interest to increase the permeability. The process may include injection of a mixture, or slurry, of particulate solids, which are often referred to as proppants, and liquids. The injection is done with sufficient pressure to produce fractures, or fracs, in the zone of interest. The proppant helps keep the fractures open after the injection pressure is removed. The preparation of the slurry at the surface may occur concurrently with the actual injection. Specialized equipment suited for this purpose may be required.

### SUMMARY

This summary is provided to introduce a selection of concepts that are described further in the detailed description below. This summary is not intended to identify key or essential features of the claimed subject matter, nor is it intended to be used as an aid in limiting the scope of the claimed subject matter.

In one aspect, embodiments of the present disclosure relate to a universal power and control unit in a manifold system that includes a control subsystem having a primary controller and a power subsystem having a power unit and at least one power connection selected from the group consisting of electrical cables, umbilical cables, pneumatic hoses, pneumatic lines, hydraulic hoses, and hydraulic lines for distributing at least one of electrical, pneumatic, and hydraulic power throughout the manifold system.

In another aspect, embodiments of the present disclosure relate to a wellbore operation system that includes an auxiliary modular skid comprising a universal power and control unit, the universal power and control unit having a power unit and a primary controller, and at least one secondary modular skid directly or indirectly connected to the auxiliary modular skid, wherein power from the power and control unit is distributed to the at least one secondary modular skids via one or more power connections.

Other aspects and advantages will be apparent from the following description and the appended claims.

### BRIEF DESCRIPTION OF DRAWINGS

Certain embodiments of the disclosure will hereafter be described with reference to the accompanying drawings, where like reference numerals denote like elements. It should be understood, however, that the accompanying figures illustrate the various implementations described herein and are not meant to limit the scope of various technologies described herein.

FIG. 1 is a schematic diagram of a conventional hydraulic fracture pad system.

FIG. 2 is a perspective view of a hydraulic fracture manifold system in accordance with one or more embodiments of the present disclosure.

FIGS. 3A and 3B are perspective views of an articulating frac arm (AFA) skid in accordance with one or more embodiments of the present disclosure.

FIG. 4 is a perspective view of a safety valve skid with a primary controller and power unit in accordance with one or more embodiments of the present invention.

FIG. 5 is a schematic diagram of a universal power and control system in accordance with one or more embodiments of the present disclosure.

### DETAILED DESCRIPTION

Embodiments of the present disclosure will now be described in detail with reference to the accompanying figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

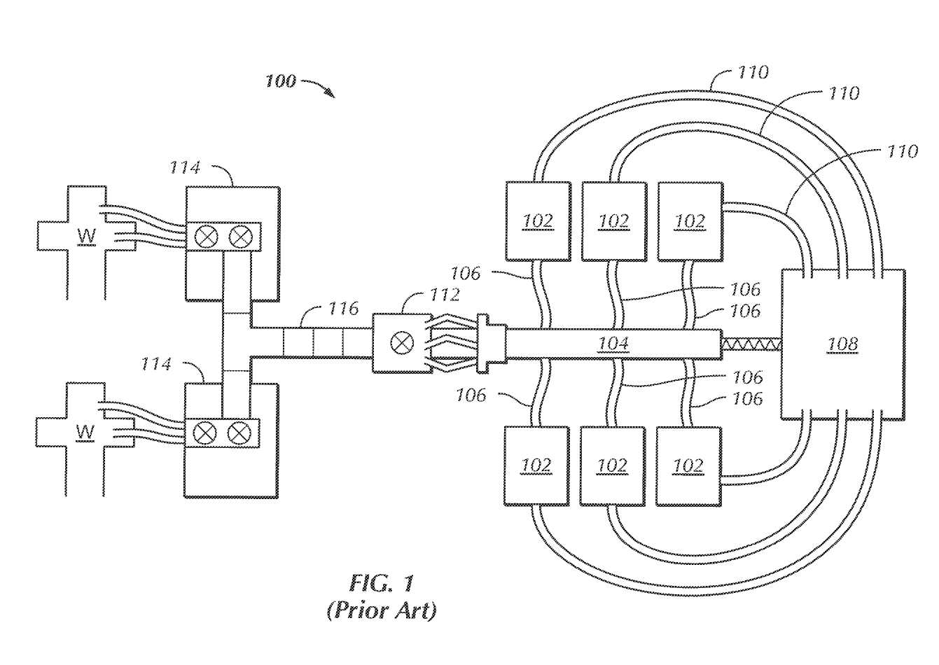

Referring to FIG. 1, a conventional hydraulic fracture, or frac, pad 100 may include a central structure that holds one or more lines used for fluid flow and to which multiple connections may be made. At least one flow line is a high-pressure flow line that may serve as a conduit for hydraulic fracturing fluid. This central structure may be referred to as a missile manifold 104. As the missile manifold 104 is often on a trailer, it may also be referred to as a missile trailer or a manifold trailer. Multiple pump trucks 102 may be connected to the missile manifold 104 via fluid connections 106. A blending system 108 may be connected to the pump trucks 102 through one or more hoses 110 to supply proppant and other particulates to the pump trucks 102 to pump into the well as part of the fracturing process. The missile manifold 104 may be connected to a valve structure 112 that, for example, can include a safety valve that opens to relieve pressure in the system under certain conditions. The valve structure 112 may be connected to zipper manifolds 114 through pipe spools 116 that are flanged together. A zipper manifold is a manifold capable of quickly shifting the fracture fluid flow from one well to another. The zipper manifold may also be referred to as a Time and Efficiency (TE) manifold. The zipper manifolds 114 may be connected to the wells W into which the hydraulic fracturing fluid may be injected under pressure.

The elements of a conventional frac pad 100 may each include separate control, power, and monitoring interfaces. For example, the missile manifold 104 may have a devoted hydraulic power system to control valves, hydraulic arms, and the like, as well as a devoted monitoring system that provides information on the status of the manifold. In a similar way, the valve structure 112 may have its own power source and control and monitoring structure.

Embodiments of the present disclosure include methods and systems related to providing universal power and control to surface equipment used in a wellbore operation system, such as a hydraulic fracturing system or a system for post-drilling fluid collection. A universal power and control system for use in a hydraulic fracturing system or other wellbore operation system may include an interconnectable power and control infrastructure used to generate or provide power, and monitor and control elements of multiple components and structures of the wellbore operation system. For example, embodiments of the present disclosure may include a universal power and control unit that may be linked to different equipment units of a wellbore operation system in a chain-like fashion, such that the universal power and control unit may provide power to and control each of the linked equipment units (unlike conventional systems using individually designed, powered and controlled systems).

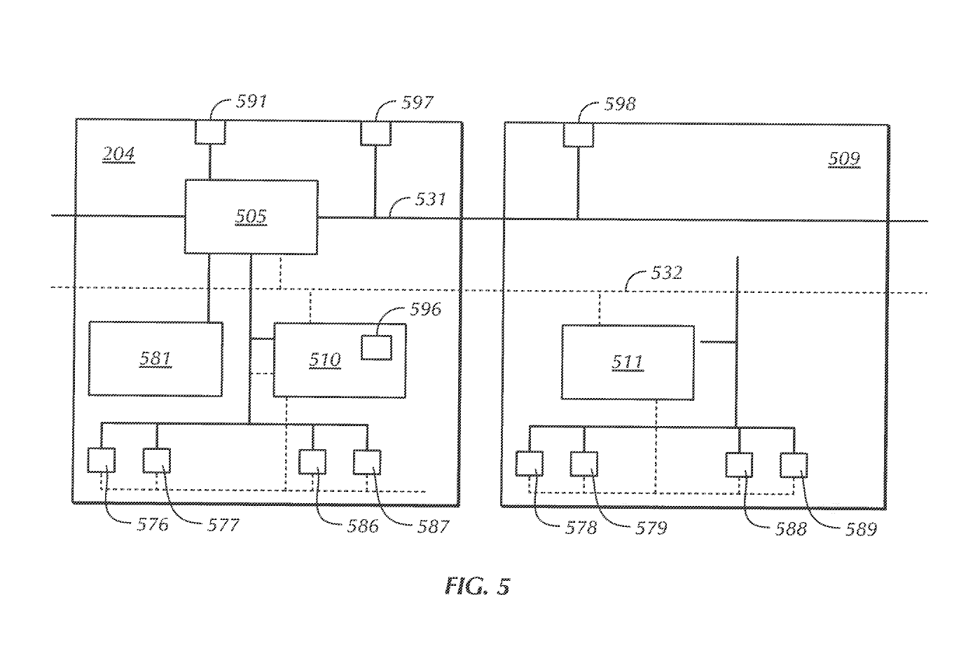

FIG. 5 shows a schematic diagram of a universal power and control system of a wellbore operation system in accordance with one or more embodiments of the present disclosure. A universal power and control unit may include a power subsystem and a control subsystem, where the power subsystem may include a power unit 505, and where the control subsystem may include a primary controller 510. In one or more embodiments, the power unit 505 and the primary controller 510 may be disposed on an auxiliary manifold modular skid 204, which is a modularized equipment unit for use in a wellbore operation to provide power and control to the system, such as described more below. A power subsystem of a universal power and control unit may further include power connections 531 for distributing electrical, pneumatic, and/or hydraulic power throughout a connected wellbore operation system. Power connections 531 may include, for example, electrical cables, umbilical cables, pneumatic hoses, pneumatic lines, hydraulic hoses, hydraulic lines, and the like, depending on the type of power being distributed through the power connections. Umbilical cables may be multi-functional and may include, for example, a coaxial cable, bare and/or insulated conductors, shielded twisted pairs, and shielded twisted quad. According to some embodiments, universal power and control units may further include one or more electric power outlets and/or one or more hydraulic outlets for localized tool use and control (shown generically as 597 and 598), as well as a single power inlet 591 to receive power from an external power source to power the entire interconnectable power and control system.

A primary controller 510 may monitor at least one sensor 576, 577, 578, 579 used in a connected wellbore operation system and control at least one controllable element 586, 587, 588, 589 used in the connected wellbore operation system (e.g., one or more of valves, actuators, or pumps of the system). For example, in one or more embodiments, a controllable element (e.g., 586) may be an electronically controlled pressure relief valve on the auxiliary manifold modular skid 204, such as described more below. According to one or more embodiments, a controller 510 may include a processor and memory. The functionality of the processor may be implemented on one or more processors. One or more programs containing instructions may be stored in the memory and executed on the one or more processors.

The control subsystem may communicate over a network 532 (wirelessly and/or through wired connections). This network may be expandable in a plug-and-play manner when elements of the wellbore operation system are connected. Further details of the control subsystem will be provided below.

In one or more embodiments, the universal power and control system may power, monitor and/or control equipment not part of a modular frac manifold system and the related environment. In one or more embodiments, the universal power and control system may provide power, monitoring, and control of equipment and the related environment from pumps used in hydraulic fracturing all the way to the well. In addition to monitoring and controlling elements discussed elsewhere in the present disclosure, zipper manifolds and frac trees may also be monitored and controlled by a universal power and control system according to embodiments of the present disclosure. A frac tree is an oil and gas well Christmas tree designed for hydraulic fracturing operations. According to one or more embodiments, the universal power and control system may monitor and/or control valve positioning and the like, and supply actuation commands to various controllable elements.

According to some embodiments of the present disclosure, universal power and control units may be provided in a modular skid, which may be used in a modular skid system having multiple purpose built modular skids that are connected together to form a multi-functional super structure for use in wellbore operations (e.g., fracturing operations). As used herein, purpose built modular skids may include modular skids according to embodiments of the present disclosure having known and/or new equipment that serves a certain purpose or performs a certain job. For example, a modular skid according to embodiments of the present disclosure may be an auxiliary modular skid having a universal power and control unit as described herein, which purpose may include providing power and control to equipment in a wellbore operation. Other equipment types currently known and/or unknown in the art (e.g., as shown in some of the examples provided herein) may be utilized in modular skids according to embodiments of the present disclosure.

Further, modular skids according to embodiments of the present disclosure may have standardized uniform mounting footprints, whether same-type or different-type equipment is mounted to the modular skids. In other words, a modular skid system according to embodiments of the present disclosure may include modular skids having same and/or different equipment configurations held on each modular skid, where each modular skid in the modular skid system may have the same mounting footprint. As used herein, a mounting footprint may refer to the size (width and length) of a base of a modular skid. Thus, in one or more embodiments, modular skids having different equipment units may have the same mounting footprint whether or not the different equipment units have different heights and/or elements of the different equipment units have different dimensions that swing or extend outward of the modular skid. For example, a modular skid system according to embodiments of the present disclosure may have a first modular skid with one or more elements of the equipment (e.g., a valve actuator or a valve connection flange) at a height above the first modular skid base and extending a distance outside of the first modular skid base width/length dimensions, and a second modular skid with an equipment unit configuration different from the first modular skid equipment, where both the first and second modular skids may have the same base width/length dimensions).

As described above, each modular skid in a modular skid system according to some embodiments of the present disclosure may have the same mounting footprint. However, in some embodiments, such as described in more detail below, a modular skid system may include one or more modular skids having a mounting footprint with one or more irregularities compared with the mounting footprints of the remaining modular skids, such that the modular skids in the modular skid system have substantially the same mounting footprints (i.e., have the same general base dimensions not including the one or more irregularities). For example, in some embodiments, a modular skid system having modular skids with bases of the same general width and length and with connection points at axial ends of the base length may include a modular skid having base with an additional connection point extending past the width of the majority of the base, while the remaining modular skids in the modular skid system may have bases without such irregularities in the base width formed by an additional connection point.

The size of modular skids (including the size of modular skid mounting footprints, modular skid heights, equipment configurations arranged on the modular skids, etc.) may be selected based, for example, on the size limitations of common transportation means, Department of Transportation (DOT) requirements (e.g., to meet weight and size limits of loads being transported on roads by trailers), the type of function each modular skid is to perform, and/or to provide reduced cost and reduced time to manufacture. For instance, the size of the mounting footprint of modular skids may be selected so that three modular skids may fit end to end on a flatbed trailer. In some embodiments, the overall size of modular skids (including the mounting footprints and the size of the equipment held on the modular skids) may be selected such that one or more modular skids may be mounted to a flatbed trailer and also meet DOT regulations for transporting the loaded flatbed trailer.

In one or more embodiments of the present disclosure, a universal power and control unit may provide power and/or control to multiple connected-together modular skids. In some embodiments, a universal power and control unit may provide power and/or control to an entire modular skid system.

Referring still to FIG. 5, the power and control unit has a power subsystem including a power unit 505, power connections 531 to other elements in the modular skid system, and optionally a primary power storage device 581 and a control subsystem including the primary controller 510. The universal power and control unit may be provided on an auxiliary manifold modular skid 204. The auxiliary manifold modular skid 204 may have additional equipment. In one or more embodiments, the auxiliary manifold modular skid 204 may have at least one electronically controlled pressure relief valve (ePRV, e.g., 586). In one or more embodiments, the universal power and control unit and two ePRVs (e.g., 586, 587) are disposed on the auxiliary manifold modular skid 204. One ePRV may be provided to relieve well pressure during wellbore operations (e.g., hydraulic fracturing) should the well pressure exceed a pre-determined limit. The relief of pressure in such a situation may prevent “over-pressuring” the well and/or equipment. In a second scenario, well isolation plug valves may be closed when the operator begins to pump. In this scenario, the pumped fluids may have nowhere to go and pressure will build. When the pressure reaches a second pre-determined limit, the ePRV will “pop off” to relieve that pressure.

In one or more embodiments of the present disclosure, power and control subsystems may be provided on secondary modular skids 509 (where modular skids without the universal power and control unit may be referred to as secondary modular skids). Each of the power and control subsystems may have a power subsystem (including power unit, power connections to other elements in the system, and optionally a secondary storage device) and a control subsystem (including a secondary controller 511).

When modular skids according to embodiments of the present disclosure are connected together to form a modular skid system, equipment units held in different modular skids may also be connected together to form a manifold having a continuous flow path formed therethrough with limited connection. Thus, modular skids according to embodiments of the present disclosure may include substantially uniform mounting footprints in addition to equipment configured to align and/or connect with equipment in adjacently mounted modular skids.

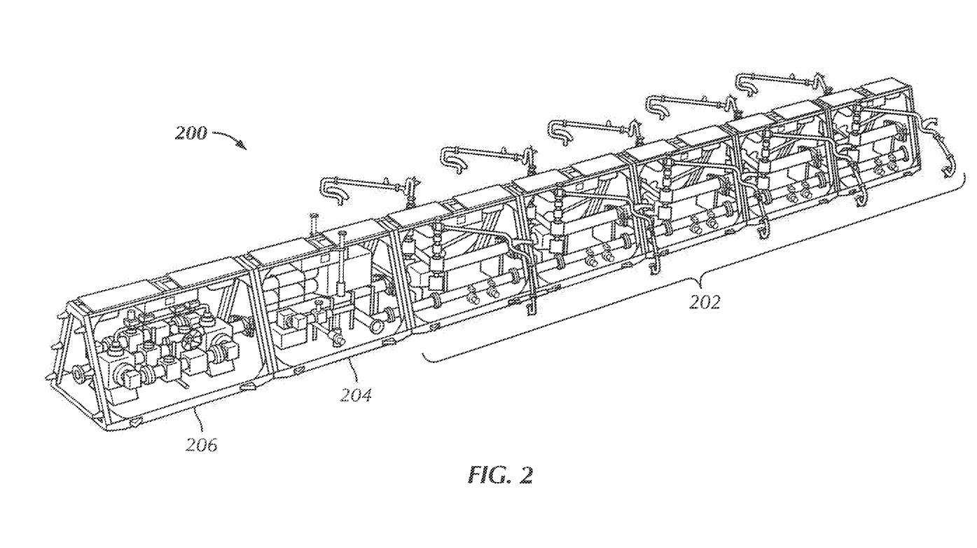

FIG. 2 shows an example of a modular skid system that is a modular frac manifold system 200 in accordance with one or more embodiments of the present disclosure. The modular frac manifold system 200 integrates multiple frac manifold systems through the use of modular skids designed to perform one or more of a subset of functions, and to include one or more of a subset of equipment, used in a frac manifold system. The modular frac manifold system 200 may include a universal power and control unit (provided on auxiliary modular skid 204 in the example shown in FIG. 2), which may be connected to universal power and control subsystems throughout the modular frac manifold system 200 (e.g., where universal power and control subsystems may be provided on one or more of modular skids 202 and 206 in the example shown in FIG. 2).

The universal power and control subsystems may be implemented in purpose-built, same-sized modular skids that are connected together to form a multi-functional uniform manifold. In one or more embodiments, modular skids may be mounted on a trailer, placed on the ground, a rig floor, or other support structure. In one or more embodiments, FIG. 2 being one example, the modular skids may be connected directly and successively to one another to create a modular frac manifold suited for a particular task and/or operating environment. In one or more embodiments, the modular skids are not connected together to form a multi-functional uniform manifold, but rather the modular skids may be separated and attached via multi-function umbilical cables. Multi-function umbilical cables may include, for example, a coaxial cable, bare and/or insulated conductors, shielded twisted pairs, shielded twisted quad, a shield and a jacket. In one or more embodiments, the umbilical cables are run along manifold portions to keep the umbilical cables off the ground.

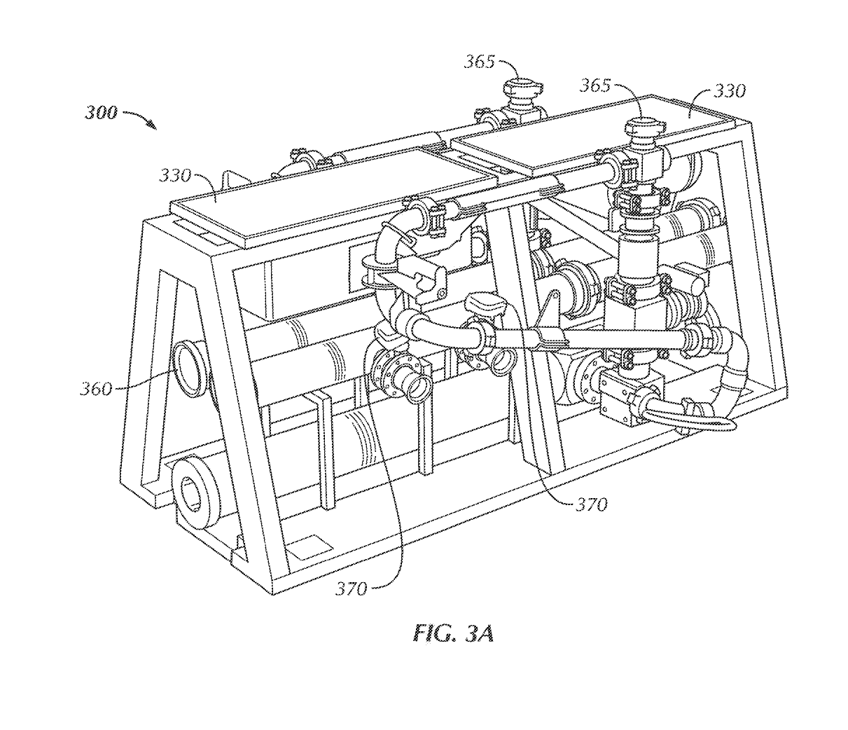

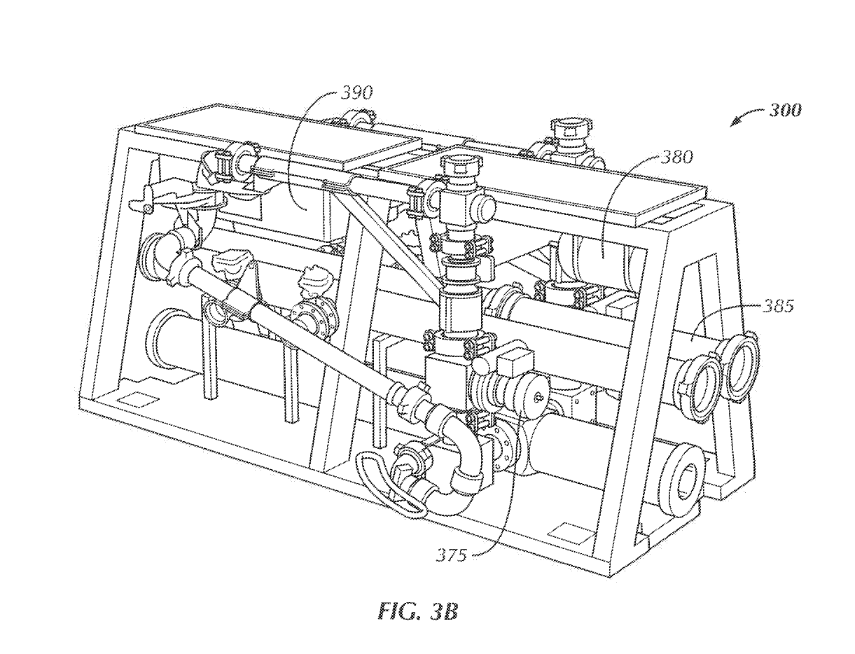

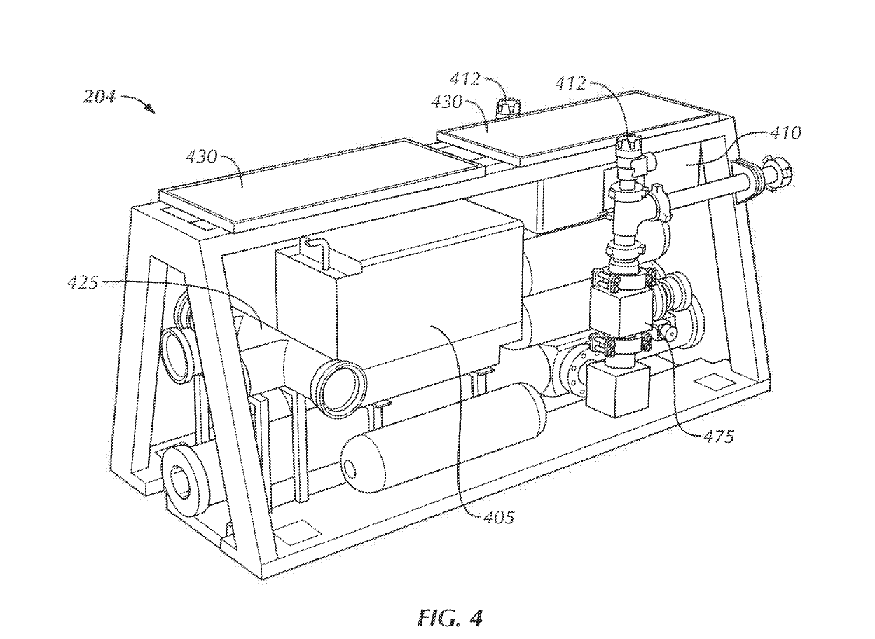

Referring to FIG. 2, the integrated frac manifold system 200 may include one or more pump modular skids 202 (e.g., having articulating frac arm (AFA) equipment or other pump connection equipment), an auxiliary modular skid 204, and an isolation modular skid 206 (having isolation equipment for isolating pump-side equipment from well-side equipment in the wellbore operation system). Integrated frac manifold systems may include other equipment (which may or may not be provided in modular skids) for use in a fracturing operation which are not shown but known to those of skill in the art. One or more embodiments of the pump modular skid 202 will be discussed in greater detail below with respect to FIGS. 3A and 3B. One or more embodiments of the auxiliary modular skid 204 will be discussed in greater detail below with respect to FIG. 4. The pump modular skids 202, auxiliary modular skid 204, and isolation modular skid 206 may include elements that require a power source to operate. These elements may include, for example, hydraulically actuated valves, electrical actuators, sensors, and the like. Rather than individually connecting a power source to these elements, a universal power and control subsystem may be incorporated into the structure of each of the modular skids, where a universal power and control unit may be connected to (directly or indirectly) and provide power to the power and control subsystems of the modular skids.

One of the modular skids depicted in FIG. 2, the auxiliary modular skid 204, may include a universal power and control unit, which may include both a primary controller and a power unit. In one or more other embodiments, the universal power and control unit may be on a different modular skid. FIG. 4 is a close-up view of auxiliary modular skid 204. In one or more embodiments, the auxiliary modular skid 204 may include a power unit 405. The power unit 405 may generate and/or supply hydraulic, pneumatic, and electrical power to each of the modular skids in the system through one or more connections between the elements of power and control subsystems through the frac manifold system. The types of connections that may be used include hoses, multi-function umbilical cables, and the like. In one or more embodiments, adjacent modular skids are connected directly as shown in FIG. 2. In one or more embodiments, the direct connections may be implemented by male and female cone connectors integrated into the modular skid frame, which may help with alignment of the modular skid frames during connection. In some embodiments, connections between adjacently positioned modular skids may be made automatically once the adjacently positioned modular skids are aligned.

In one or more embodiments, the auxiliary modular skid 204 having the universal power and control unit (including the primary controller 510 and the power unit 505) may be deployed first. The elements of the auxiliary modular skid 204, for example, valves and the like, may communicate with the primary controller 510 of the universal power and control unit either directly or indirectly through a secondary controller. These elements may also receive power from the power unit 505 of the universal power and control unit.

The remaining modular skids 509, for example, a pump modular skid 202, an isolation modular skid 206, and the like, may be effectively powerless until they are energized by being connected directly to the universal power and control unit of the auxiliary modular skid 204 or indirectly to the universal power and control unit of the auxiliary modular skid 204 through one or more intermediate modular skid(s) that is already energized from the universal power and control unit.

In one or more embodiments, a modular skid containing a universal power and control unit may be referred to as an auxiliary manifold skid, and modular skids without the universal power and control unit may be referred to as secondary modular skids. In some embodiments, auxiliary manifold skids 204 may include one or more pressure relief valves (PRVs) in addition to the universal power and control unit, such as shown with the auxiliary modular skid 204, such that the auxiliary manifold skid may be multi-purpose built to generate/supply a central power and control source and to provide emergency valve shut-off or pressure relief. In one or more embodiments, the PRVs may be ePRVs. The pressure relief valves may be used to provide emergency relief of pressure in wellbore operation systems. In some embodiments, an auxiliary manifold skid may be multi-purpose built to generate/supply a central power and control source and to provide one or more functions different than emergency valve shut-off or pressure relief (where equipment other than PRVs may be provided on the auxiliary manifold skid in addition to the universal power and control unit). In some embodiments, an auxiliary manifold skid may be single-purpose built to generate/supply a central power and control source (where equipment not used for the universal power and control unit may be provided in secondary modular skids).

Referring again to FIG. 5, auxiliary manifold skids 204 may have a universal power and control unit incorporated therein, which may include a power subsystem and a control subsystem. In some embodiments, a power subsystem in a universal power and control unit may include a primary power unit 505, power connections 531 for distributing electrical, pneumatic, and hydraulic power (e.g., wires, cables, hoses, lines), and optionally, a primary storage device 581 for storing power. A control subsystem in a universal power and control unit may include a primary controller 510, which may, for example, direct controls and/or other signals (e.g., measurement signals) to and/or from the power and control system.

Secondary modular skids 509 may have universal power and control subsystems incorporated therein. In one or more embodiments, the universal power and control unit and the universal power and control subsystems may each include a power subsystem and a control subsystem. In some embodiments, a power subsystem in a universal power and control subsystem may include a secondary power unit, power connections for distributing electrical, pneumatic, and hydraulic power (e.g., wires, cables, hoses, lines), and optionally, a secondary storage device for storing power. A control subsystem in a universal power and control subsystem may include a secondary controller 511 that receives power from the primary power unit 505 of the universal power and control unit on the auxiliary manifold skid 204 (or a secondary power unit such as solar panels on a secondary modular skid 509). The secondary controller 511 may communicate to and from the primary controller 510 of the universal power and control unit on the auxiliary manifold skid 204. The secondary controller 511 may also monitor the sensors 578, 579 and control the controllable elements 588, 589 on the secondary modular skid 509.

In one or more embodiments, a secondary controller 511 may have an identifier stored therein. Further, identifiers may be associated with monitoring and/or controllable elements (e.g., sensors, electronically controlled valves, etc.) on any modular skid. Each modular skid, each monitoring element, and each controllable element may be individually addressable. In one or more embodiments, there may be a handshaking process when a secondary modular skid is directly or indirectly connected to an auxiliary manifold skid. The handshaking process causes the identifiers of the secondary modular skids 509 to be loaded into the primary controller 510 in an addressable structure. In other words, identifiers in one or more secondary modular skids 509 may have an “address,” or location of each monitoring and/or controllable element associated with the identifiers, and when signals are received from and/or transmitted to the monitoring and/or controllable elements, the identifiers may provide the address of the monitoring and/or controllable element from which each signal is received from and/or transmitted to along with the signal transmission. In such manner, signals to/from different monitoring elements 578, 579 and/or controllable elements 588, 589 on secondary modular skids 509 may be transmitted and identified via secondary controllers 511 on the secondary modular skids 509.

In one or more embodiments, a primary controller 510 may include a communication interface 596 through which the primary controller 510 communicates with a control interface at a location remote from the frac manifold system (e.g., through wireless communication). A remote location may be any location not physically connected to the frac manifold system. In one or more embodiments, the remote location may be at the wellsite. In one or more other embodiments, the remote location may be thousands of miles away. In one or more embodiments, the communication interface 596 may be a wireless communication interface. In some embodiments, a primary controller 510 may communicate with a control interface via a wired connection. The primary controller 510 may communicate to the control interface what modular skids and/or elements are connected to the universal power and control system. The communication provides for up-to-date identification and control of the skids and/or elements.

In one or more embodiments, the universal power and control system may have one or more power outlets at the power and control subsystems and/or at the universal power and control unit that may allow for site workers to connect tools and the like for maintenance work. As an example, each modular skid may include at least one set of outlets 597, 598 for electrical, hydraulic, or pneumatic power. Outlets may be used by site workers when, for example, a valve on a modular skid needs to be replaced. In this way, the tool can be connected as closely as possible to limit the number of hoses on the ground, thus reducing the number of safety hazards.

In one or more embodiments, the universal power and control system may include one or more power units 505 for electrical generation (e.g., a power unit in the universal power and control unit, and optionally, one or more secondary power units in universal power and control subsystems). For example, solar panels (e.g., solar panels 330, 430 in FIGS. 3A-4) mounted on one or more of the modular skids may be a source of electrical power. In one or more embodiments, an internal combustion engine may drive an electrical generator as a power source. In one or more embodiments, the engine may be a diesel engine. The internal combustion engine may use such fuels as gasoline, diesel fuel, natural gas, and the like. In some embodiments, a first type of power unit may be used for the universal power and control unit (e.g., on an auxiliary manifold skid), and a different type of power unit (e.g., solar panels) may be used for one or more universal power and control subsystems.

In one or more embodiments, the universal power and control system may include one or more power storage devices in addition to one or more power units. Power units for generating power and storage devices may be incorporated into the inter-skid electrical connections such that the universal power and control system can both provide power to electrical elements on the modular skids and receive and store power from the electrical generation elements. In one or more embodiments, the universal power and control unit may include a primary storage device, e.g., batteries or the like, in addition to the primary controller and the power unit. In one or more embodiments, the primary storage device 581 may receive and store power generated at the secondary modular skids 509. In one or more embodiments, one or more of the secondary skids 509 may have local power storage elements. In one or more embodiments, the power unit 505 may include a hydraulic power unit (HPU).

In one or more embodiments, controllable elements 586, 587, 588, 589 on the modular skids 204, 509 may include hydraulically-, pneumatically-, or electrically-actuated valves. As an example, see the pump modular skid 300 shown in two different perspective views in FIGS. 3A and 3B. The pump modular skid 300 may include at least one articulating frac arm 365. An articulating fracture arm 365 may include a hydraulic cylinder that provides an upward lift on the lower arm to help the arm feel “weightless.” This may allow a user to swing the arm without having to lift the arm's weight. Further, each pump modular skid may include an HPU to provide pressure to the hydraulic cylinders associated with the AFAs and a local hydraulic accumulator 380 for shock absorption. Shock absorption may be necessary because of vibration of the AFA during fracturing operations. In one or more embodiments, the universal power and control system may monitor one or more hydraulic pressures on a pump modular skid, control the pressure to within pre-determined levels, and provide additional hydraulic power/pressure to enable proper functioning of the skid. Failure to maintain proper hydraulic support for the AFA may cause the weight of the AFA to load up on connections and cause failures. In one or more embodiments, the pump modular skid 300 may include one or more vane (pneumatic) actuated butterfly valves 370 and/or one or more hydraulically-actuated valves 375. In one or more embodiments, the pump modular skid 300 may include a low pressure (LP) header 360 and hose 385.

As presented above, FIG. 4 shows an example of an auxiliary modular skid 204 according to one or more embodiments of the present disclosure. The auxiliary modular skid 204 may include one or more ePRVs 412. An ePRV 412 may be electrically powered and require no gas bottles or hoses. The ePRV 412 may pop open in the event power is lost, unless a battery backup is employed. The safety valve skid 204 in one or more embodiments may include a low pressure header 425, which may connected to other low pressure flow paths in adjacently connected modular skids. In one or more embodiments, the auxiliary modular skid 204 may include a power unit 405, which is part of the universal power and control unit that provides power to the entire modular frac manifold system.

In one or more embodiments, the auxiliary modular skid 204 may also include a central electronic unit 410. The central electronic unit 410 may serve as the primary controller of the universal power and control unit of the modular frac manifold system. The central electronic unit may contain programmable logic controllers (PLC), sensors, and solar panel controllers. In one or more embodiments, the programmable logic controller monitors at least one sensor and makes decisions based upon a program to control the state of at least one controllable element.

In one or more embodiments, a plurality of modular skids may have components of a universal power and control system. In one or more embodiments, the controller on the auxiliary modular skid 204 operates as the primary controller 510. In one or more other embodiments, a different purpose built modular skids may house the primary controller.

In one or more embodiments, individual modular skids are provided with solar panels (e.g., solar panels 330, 430) and local batteries. These may be used with work area flood lights, but may also be integrated into the universal power and control system for a wellbore operation system (e.g., where the solar panels and/or local batteries may provide power to other connected elements in the universal power and control system).

Sensors can include, for example, vibration sensors, pressure sensors, temperature sensors, and the like. Sensors 578, 579 may communicate conditions to secondary controllers 511, which then communicate the conditions with appropriate identifiers attached to the primary controller. The primary controller 510 may then transmit the communicated conditions to a user interface, which may display the conditions in a manner that associates the condition with the appropriate modular skid and sensor, such that a user can immediately identify problem elements for repair and the like.

According to embodiments of the present disclosure, a primary controller of a universal power and control system may communicate conditions of equipment in communication with the universal power and control system (e.g., monitoring elements, such as sensors, and controllable elements), for example, via secondary controllers. Thus, in embodiments where a universal power and control system is in communication with equipment throughout an entire wellbore operation system, the user interface may provide communicated feedback from the entire system, from a pump to the well.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A universal power and control unit in a manifold system, the universal power and control unit comprising:
a power subsystem comprising:
a power unit; and
at least one power connection selected from the group consisting of electrical cables, umbilical cables, pneumatic hoses, pneumatic lines, hydraulic hoses, and hydraulic lines for distributing at least one of electrical, pneumatic, and hydraulic power throughout the manifold system; and
a control subsystem comprising:
a primary controller.

2. The universal power and control unit of claim 1, wherein the power subsystem further comprises a single power inlet.

3. The universal power and control unit of claim 1, wherein the power subsystem further comprises at least one power outlet.

4. The universal power and control unit of claim 1, wherein the power subsystem further comprises a primary energy storage device.

5. The universal power and control unit of claim 1, wherein the primary controller monitors at least one sensor in the manifold system and controls at least one controllable element in the manifold system, the at least one controllable element comprising one or more of valves, actuators, or pumps.

6. The universal power and control unit of claim 5, wherein the primary controller comprises a programmable logic controller, wherein the programmable logic controller monitors the at least one sensor and makes decisions based upon a program to control the state of the at least one controllable element.

7. The universal power and control unit of claim 1, wherein the primary controller controls at least one pressure relief valve.

8. The universal power and control unit of claim 1, wherein the power unit is an electrical generator.

9. The universal power and control unit of claim 1, wherein the universal power and control unit is disposed on a single modular skid.

10. The universal power and control unit of claim 1, the primary controller further comprising:
a communication interface that communicates with a location remote from the manifold system.

11. The universal power and control unit of claim 10, wherein the communication interface comprises a wireless communication interface.

12. A wellbore operation system, comprising:
an auxiliary modular skid comprising a universal power and control unit, the universal power and control unit comprising:
a power unit; and
a primary controller; and
at least one secondary modular skid directly or indirectly connected to the auxiliary modular skid,
wherein power from the power and control unit is distributed to the at least one secondary modular skids via one or more power connections.

13. The system of claim 12, wherein the auxiliary modular skid further comprises multiple pressure relief valves.

14. The system of claim 12, wherein at least one of electrical, pneumatic, or hydraulic power is distributed through the wellbore operation system from the universal power and control unit.

15. The system of claim 12, wherein the at least one secondary modular skid comprises a power and control subsystem in communication with the universal power and control unit.

16. The system of claim 15, wherein the universal power and control unit connects automatically to the power and control subsystem when the auxiliary modular skid is connected to the at least one secondary modular skid.

17. The system of claim 15, wherein the power and control subsystem comprises a secondary controller, and wherein the primary controller communicates with the secondary controller.

18. The system of claim 12, further comprising at least one sensor or at least one controllable element in communication with the universal power and control unit, the at least one controllable element comprising one or more of valves, actuators, or pumps.

19. The system of claim 18, wherein the at least one sensor or the at least one controllable element is in communication with the universal power and control unit via a secondary controller in a power and control subsystem on the at least one secondary modular skid, where the secondary controller identifies and communicates with the at least one sensor or the at least one controllable element.

20. The system of claim 18, wherein a unique identifier is associated with each of the auxiliary modular skid, the at least one secondary modular skid, and the at least one sensor or controllable element in the modular frac manifold system.
